(19) United States
(12) Patent Application Publication
(10) Pub. No.: US 2013/0157654 A1
(43) Pub. Date: Jun. 20, 2013

(54) CELL PHONE CONTAINER WITH RADIATION SHIELDING

(71) Applicant: DOROTHY GAINE, Newbury Pk, CA (US)

(72) Inventor: DOROTHY GAINE, Newbury Pk, CA (US)

(21) Appl. No.: 13/327,484

(22) Filed: Dec. 15, 2011

(51) Int. Cl. H04W 88/02; H04W 40/00

(52) U.S. Cl. 455/426.1; 455/575.5

(57) ABSTRACT

A radiation shielding container for a cell phone may include a main body lined with lead. The main body may be provided with a placement port large enough to permit insertion of the cell phone into the main body. A lead-lined flap may be attached to the main body and configured to overly a portion of the main body.

### BACKGROUND OF THE INVENTION

The present invention generally relates to radiation shielding for cell phones.

Some studies have concluded that extensive use of cell phones held next to a user's ear may result in brain tumors within a certain fraction of those users. Cell phones emit radiation even when not in use. Additionally, studies have concluded that harmful personal radiation effects may occur even when a user is across a room from a cell phone.

Studies from the World Health Organization (WHO) and various scientists have concluded that children are particularly vulnerable to radiation effects because their brains are in a formative stage.

As can be seen, there is a need to limit potential radiation exposure of people in the presence of cell phones.

### SUMMARY OF THE INVENTION

In one aspect of the present invention, a radiation shielding container for a cell phone may comprise: a main body lined with lead; a placement port in the main body large enough to permit insertion of the cell phone into the main body; and a lead-lined flap attached to the main body and configured to overly a portion of the main body.

In another aspect of the present invention, a method for operating a cell phone may comprise the steps of: placing the cell phone into a lead lined container; and receiving and making calls with the phone using short-range-radio transmission between the cell phone in the container and a receiver outside of the container.

These and other features, aspects and advantages of the present invention will become better understood with reference to the following drawings, description and claims.

### BRIEF DESCRIPTION OF THE DRAWINGS

FIG. 1 is a perspective view of a radiation shielding cell phone container in accordance with an embodiment of the invention;

FIG. 2 is an elevation view of the container of FIG. 1;

FIG. 3 is a perspective view of the container of FIG. 1 in an open position;

FIGS. 4 and 5 are perspective views of the container of FIG. 1 showing operational features;

FIG. 6 is a perspective view of the container of FIG. 1 with a cell phone in an operational mode;

FIG. 7 is a cross-sectional view of the container of FIG. 6 taken along the line 6-6; and

FIG. 8 is a schematic view of radiation blockage achieved by the container of FIG. 1.

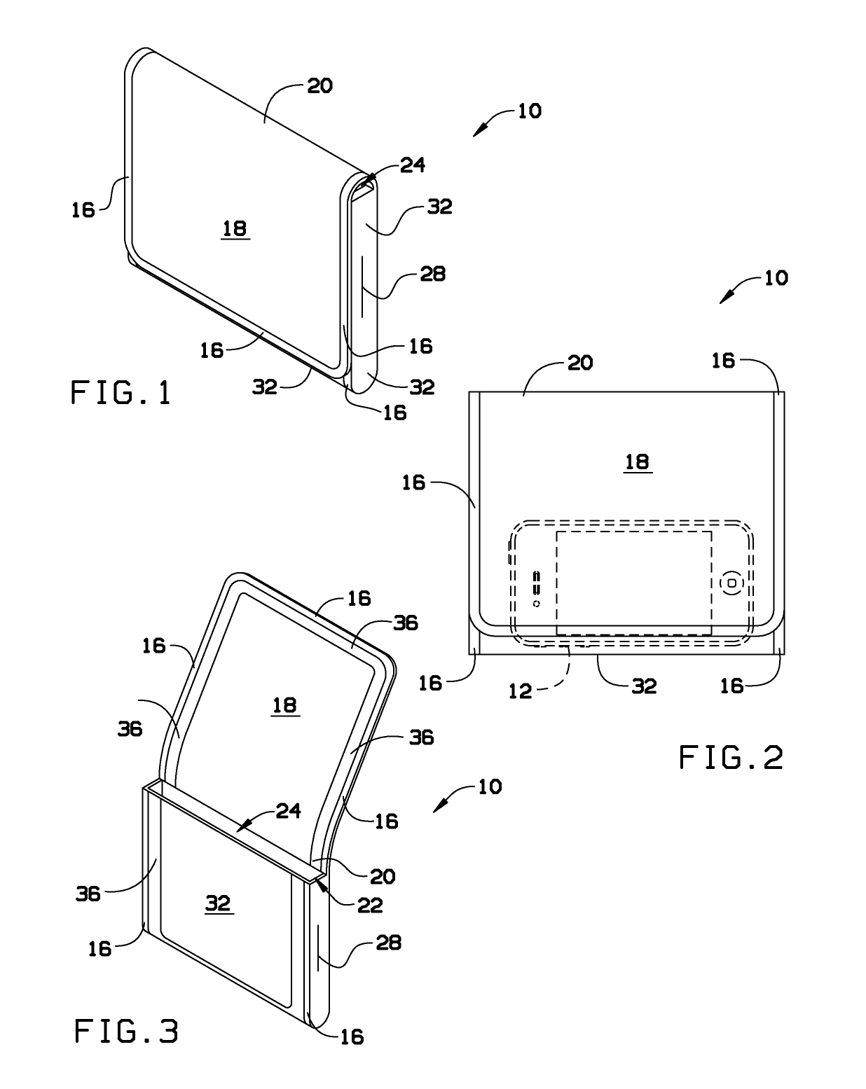

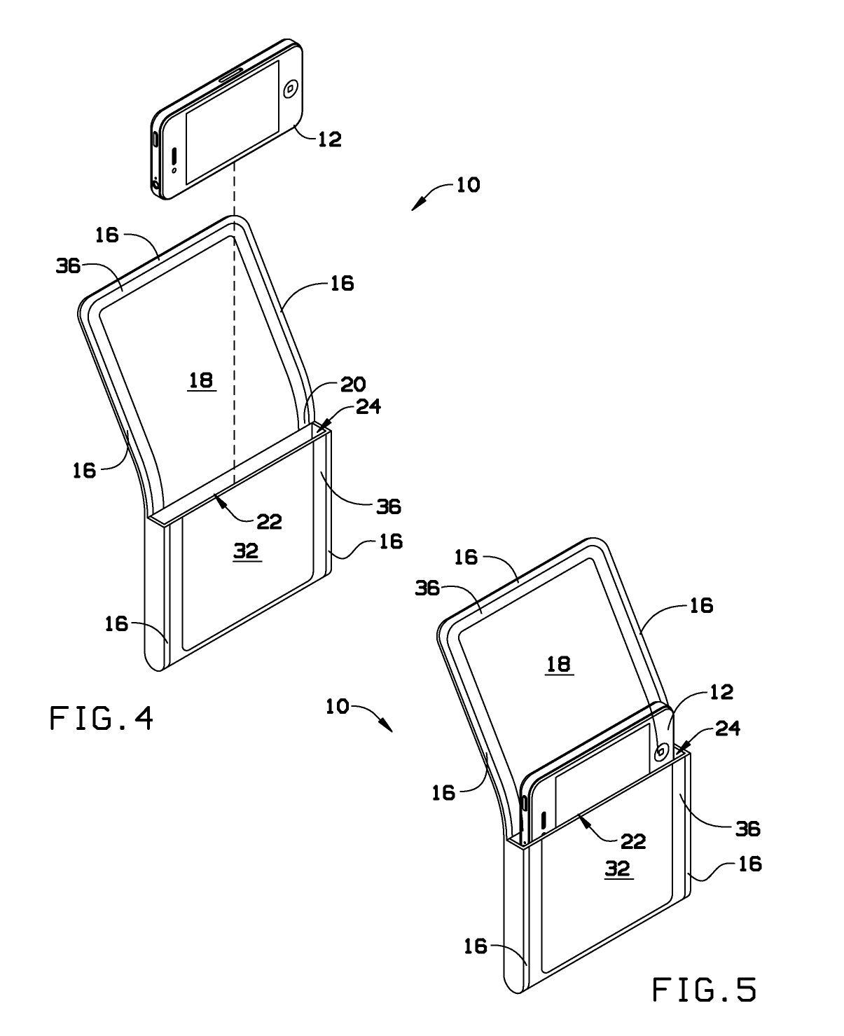

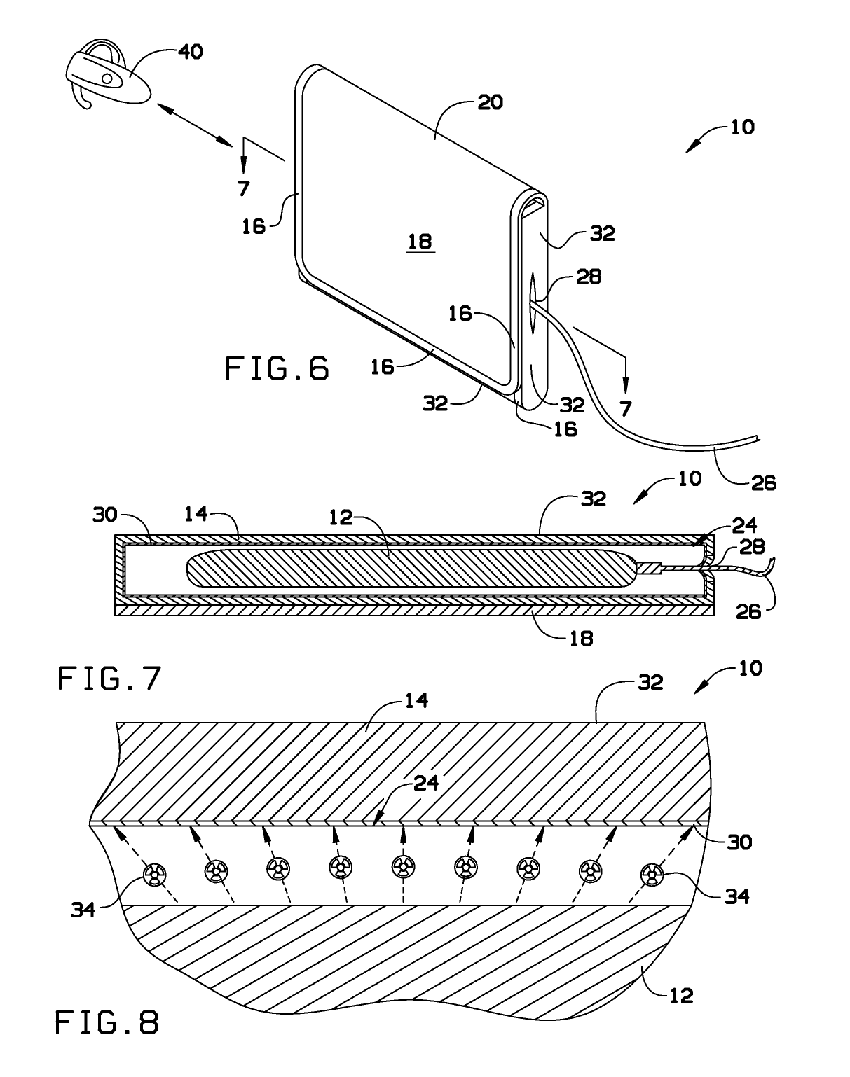

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide lead-lined covering containers for a cell phone which may act to block radiation emission from the cell phone.

Referring now to the Figures, It may be seen that an exemplary embodiment of a radiation shielding cell phone container 10 may comprise a main body 32, a vinyl cover 14, vinyl trim tape 16, a flap 18, a flap bend joint 20, a placement port 22, a phone cavity 24, a charging wire port 28 and a lead lining 30. Strips 36 of hook and loop fasteners may be provided to hold the flap 128 in a closed position over the main body 32.

The container 10 may provide radiation shielding of a cell phone 12. The main body 32 and the flap 18 may be constructed from a laminate of plastic film and lead. The cell phone 12 may be placed into the container 10 through the port 22 and the flap 18 may then be folded over the port 22 to overly the main body 32. The flap 18 may be attached to the main body 32 with the bendable joint 20. Hook and loop fasteners strips 34 may be attached to the flap 18 and to the main body 32 and configured to hold the flap 18 against the main body 32 when the flap 18 is closed. The main body 32 may be provided with a charging wire port 28.

Advantageously the container 10 may be flexible. In that regard, it may be desirable to construct the container 10 from laminate that may comprise vinyl film and lead foil wherein the lead foil may have a thickness no greater than about 0.005 inch.

When the cell phone 12 is enclosed within the container, radiation sub-atomic particles 34 that may be emitted from the cell phone 12 may be blocked for emerging from the container. Thus a person near the cell phone 12 may be protected from harmful effects of such radiation.

It may be noted that the cell phone 12 may still be used to communicate even though it may be enclosed in the container 10. This may be accomplished by utilizing a conventional short-range radio transmission device 40 (e.g., a BlueTooth® device) located outside of the container 10.

It should be understood, of course, that the foregoing relates to exemplary embodiments of the invention and that modifications may be made without departing from the spirit and scope of the invention as set forth in the following claims.

What is claimed is:

1. A radiation shielding container for a cell phone comprising:
a main body lined with lead;
a placement port in the main body large enough to permit insertion of the cell phone into the main body; and
a lead-lined flap attached to the main body and configured to overly a portion of the main body.

2. The container of claim 1 wherein the main body comprises flexible material.

3. The container of claim 1 wherein the main body comprises a laminate of vinyl and lead.

4. The container of claim 1 wherein the flap is attached to the main body with a bendable joint.

5. The container of claim 1 wherein the main body and the flap comprise a laminate of vinyl and lead.

6. The container of claim 5 wherein the laminate comprises lead foil having a thickness no greater than about 0.005 inch.

7. The container of claim 1 further comprising hook and loop fasteners strips attached to the flap and to the main body and configured to hold the flap against the main body.

8. The container of claim 1 wherein the main body is provided with a charging wire port.

9. A method for operating a cell phone comprising the steps of:
placing the cell phone into a lead lined container; and
receiving and making calls with the phone using short-range-radio transmission between the cell phone in the container and a receiver outside of the container.

10. The method of claim 9 wherein the sep of placing the cell phone in a container comprises placing the phone into a lead lined main body of the container and then closing a lead-lined flap of the container
